(19) United States
(12) Patent Application Publication
(10) Pub. No.: US 2023/0254475 A1
(43) Pub. Date: Aug. 10, 2023

(54) COLOR TUNED OPTICAL MODULES WITH COLOR CALIBRATION OPERATIONS

(71) Applicant: Meta Platforms, Inc., Menlo Park, CA (US)

(72) Inventors: Kian Kerman, Monte Sereno, CA (US); Quintin Morris, Seattle, WA (US); Paul LeFebvre, Brookings, OR (US); Seyed-Ali Madani, Sunnyvale, CA (US); Dong Rim Lee, San Jose, CA (US); Tristan Tom, Hillsborough, CA (US)

(21) Appl. No.: 17/592,957

(22) Filed: Feb. 4, 2022

(51) Int. Cl. H04N 17/02; H04N 9/09; H04N 9/73; H04N 9/04; H04N 5/33; G02B 27/01; G06F 1/16

(52) U.S. Cl. CPC H04N 17/02; H04N 9/09; H04N 9/735; H04N 9/0451; H04N 5/332; H04N 9/04553; H04N 9/04557; G02B 27/0172; G06F 1/163; G02B 2027/0138; G02B 2027/014; G02B 2027/0112; G02B 2027/0178

(57) ABSTRACT

The present invention provides systems and methods for color tuning optical modules and executing color calibration methods on artificial reality systems and devices. Embodiments can include a lens with a colored coating, a plurality of cameras, including a visible spectrum camera and an infrared camera, each positioned behind the lens, and a processor and memory. The colored coating includes a plurality of regions for selectively transmitting light. The processor and memory can be configured to receive light information indicative of environmental information for executing an operation on the device, identify wavelengths of light reflected by the color profile in front of each camera, determine a color calibration to amplify wavelengths of reflected light, update the environmental information based on the color calibration, and execute the operation on the device.

### TECHNICAL FIELD

The present disclosure generally relates to systems and methods for color calibration using artificial reality devices with color tuned exteriors.

### BACKGROUND

Artificial reality is a form of reality that has been adjusted in some manner before presentation to a user. Artificial reality can include, e.g., a virtual reality (VR), an augmented reality (AR), a mixed reality (MR), a hybrid reality, or some combination and/or derivatives thereof. AR, VR, MR, and hybrid reality devices often receive information through cameras or other optical modules on a headset, e.g., glasses, and provide content through visual means.

Since artificial reality devices heavily rely on accurate optical information to provide seamless and realistic output for users, the devices rarely have any color cosmetics added due to the stringent optical requirements of any cameras and/or optical modules behind the cover windows, e.g., lenses. Moreover, colored cover windows act as a color filter and create significant challenges to the complex operations of cameras and other optical modules utilizing received and transmitted light.

### SUMMARY

In meeting the described challenges, the present disclosure provides systems and methods for color tuning optical modules and executing color calibration methods on artificial reality systems and devices. Exemplary embodiments include artificial reality systems with colored lenses specifically tuned to the optical modules of the system. The optical modules can be cameras, such as infrared cameras, visible spectrum cameras, and the like.

In one exemplary embodiment, a device includes a lens, a plurality of cameras positioned behind the lens, a colored coating on the lens, and a processor and non-transitory memory including computer-executable instructions. The plurality of cameras can include a first camera for processing visible light and a second camera for processing infrared light. The colored coating includes a plurality of regions, with each region having a color profile for selectively transmitting light. A first region is positioned in front of the first camera and the second region is positioned in front of the second camera.

The computer-executable instructions, when executed by the processor, cause the device to receive light information indicative of at least one of: visible light received at the first camera or infrared light received at the second camera, wherein the received light information provides environmental information for executing an operation on the device; identify wavelengths reflected by the color profile positioned in front of each camera; determine a color calibration for the light information based on the color profile, wherein the color calibration amplifies the wavelengths reflected by the color profile; update the environmental information based on the color calibration; and execute the operation on the device based on the updated environmental information.

Additional embodiments include a laser emitter positioned behind the lens and a third region on the colored coating having a color profile for selectively transmitting infrared light. Embodiments can include two regions for transmitting light, and a region for transmitting infrared light positioned between the two visible light regions.

The colored coating can include a first plurality of layers on an inner face of the lens, and a second plurality of layers on an outer face of the lens. The first plurality of layers can include an inner ink layer, a middle high-contrast layer, and an outer anti-reflective layer. The second plurality of layers can include an inner hard-coat (HC) layer, a middle anti-reflective (AR) layer, and an outer anti-fingerprint (AF) layer. The HC layer increases adhesion between the substrate material and the AR layer and improves performance against scratches and abrasion. The colored coating can also include a plurality of ink layers, with each ink layer reflecting a range of wavelengths.

In embodiments, the second region has less than a 20% transmission rate for wavelengths below 750 nm. In another embodiment, the second region has less than a 10% transmission rate for wavelengths below 730 nm. In another embodiment, the second region has less than a 5% transmission rate for wavelengths below 700 nm. In another embodiment, the second region has greater than a 60% transmission rate for wavelengths above 850 nm.

Each region can include an on-axis color profile, and an off-axis color profile. The on-axis color profile can have greater than a 90% transmission rate for wavelengths above 500 nm. In other embodiments, the on-axis color profile can have greater than a 96% transmission rate for wavelengths between 500-700 nm. The off-axis color profile can have a transmission rate of greater than 64% for wavelengths above 500 nm. The off-axis color profile can have a transmission rate of greater than 73% for wavelengths between 500-700 nm.

In embodiments, the first camera identifies red, green, blue, and yellow wavelength values. Each color profile can further include a transmission profile and reflection profile. The operations on the device can include one or more of generating an image on a display or executing a simultaneous location and mapping (SLAM) function. In some embodiments, the colored coating can be applied to the lens using a pad printing technique. The lens formation and colored coating can also be performed using a thermoformed or injection molding technique. In other embodiments, a colored coating can be applied to the lens using at least one of sputtering and e-beam evaporation techniques.

Exemplary embodiments of the present invention can utilize a variety of hardware, such as glasses, headsets, controllers, peripherals, mobile computing devices, displays, and user interfaces to effectuate the methods and operations discussed herein. Embodiments can further communicate with local and/or remote servers, databases, and computing systems. In various embodiments, the artificial reality device can include glasses, a headset, a display, a microphone, a speaker, and any of a combination of peripherals, and computing systems.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates a lens in accordance with embodiments of the present invention.

FIG. 2A illustrates image signal processing operations in accordance with embodiments of the present invention.

FIG. 2B illustrates example reflected colors in accordance with the embodiments of the present invention.

FIG. 3 illustrates an example flowchart for executing operations in accordance with the present invention.

FIG. 4 illustrates an example flowchart illustrating color calibration operations in accordance with the present invention.

FIG. 5A illustrates an example transmission vs. wavelength graph for a coating in accordance with embodiments of the present invention.

FIG. 5B illustrates an example reflection (%) versus wavelength (nm) graph for a coating in accordance with embodiments of the present invention.

FIG. 5C illustrates another example reflection (%) versus wavelength (nm) graph for a coating in accordance with embodiments of the present invention.

FIG. 5D illustrates an example transmission (%) versus wavelength (nm) graph for a coating in accordance with embodiments of the present invention.

FIG. 6 illustrates a lens layer design in accordance with embodiments of the present invention.

FIG. 7 illustrates a reflection color profile in accordance with embodiments of the present invention.

FIG. 8 illustrates a transmission color profile in accordance with embodiments of the present invention.

FIG. 9 illustrates a thermoform process in accordance with embodiments of the present invention.

FIG. 10 illustrates an injection molding process in accordance with embodiments of the present invention.

FIG. 11 illustrates a sputter deposition apparatus in accordance with embodiments of the present invention.

FIG. 12 illustrates an electron-beam evaporation apparatus in accordance with embodiments of the present invention.

FIG. 13 illustrates an AR headset in accordance with embodiments of the present invention.

FIG. 14 illustrates another head-mounted AR headset in accordance with embodiments of the present invention.

FIG. 15 illustrates a block diagram of a hardware/software architecture in accordance with embodiments of the present invention.

FIG. 16 illustrates a block diagram of an example computing system according to an exemplary aspect of the application.

FIG. 17 illustrates a computing system in accordance with exemplary embodiments of the present invention.

### DETAILED DESCRIPTION OF ILLUSTRATIVE EMBODIMENTS

The present disclosure provides systems and methods for color tuning optical modules and executing color calibration methods. Embodiments discussed herein allow for cosmetic color tuning on a lens or cover window, with the colored coating having specific optical functionality for camera and optical modules adjacent to it. As applied to artificial reality devices, lenses of such devices can be tuned to reflect a particular color in non-camera area and transmit a known but different color in camera areas. As such, any color effects due to lenses in front of the cameras can be calibrated to promote optimal camera performance.

Embodiments include unique optical stack combinations, using anti-reflective, infrared, and/or opaque ink, for example. Such devices and color calibrations techniques can be applied to cameras for specified wavelengths, such as infrared in the 840-860 nm range, the visible spectrum range, and others.

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately or in any sub combination. Further, any reference to values stated in ranges includes each and every value within that range. Any documents cited herein are incorporated herein by reference in their entireties for any and all purposes.

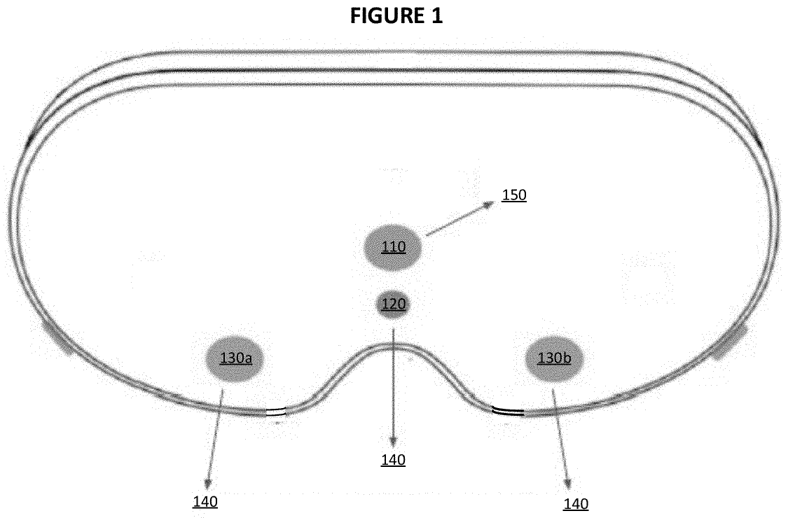

FIG. 1 illustrates a front view of a lens 100 of a device, such as an artificial reality device, in accordance with embodiments. The lens 100 comprises a plurality of regions having unique optical characteristics. The regions can comprise color profiles, e.g., a reflection color profile and/or a transmission color profile that selectively tune light traveling through the regions. The optical characteristics can further comprise on-axis and off-axis color profiles, with different optical characteristics.

In various embodiments, lenses can appear to be a single, uniform color, despite a plurality of regions with unique optical characteristics. The coating on the lens can comprise a plurality of regions, each of which serves to simultaneously reflect a particular color, while transmitting a known but different color. Camera modules and other hardware behind each lens region can calibrate out the known color distortion to enable normal functionality. Accordingly, the coating, with its distinct color regions, enables the creation and use of lenses in a plurality of colors and designs for a variety of devices, such as AR headsets, other head-mounted devices, and technologies utilizing light filtered through a lens.

An artificial reality device, for example, can comprise a plurality of cameras configured to receive light transmitted through the lens. The lens coating, such as a colored coating, affects the transmission of light through the lens. For example, a lens with a black color coating will typically have a much lower transmission rate than a clear lens. Similarly, the colored lens can act as a filter to light passing through. Cameras receiving light through the lens can be tuned to the unique color characteristics of the lens to ensure accuracy in various operations executed in response to the received image(s).

In embodiments, a lens can comprise a plurality of regions tuned to provide specific optical characteristics based on the hardware, e.g., cameras, light emitters, etc., behind the lens. Lens 100 comprises a plurality of regions tuned to optimize operations related to visible light and infrared light. In particular, region 110 can optimize operations utilizing light in the infrared spectrum 150, and regions 120, 130a, and 130b can optimize operations utilizing light in the visible spectrum 140. The size of each region 110,120, 130a, 130b can vary, and may be the same or different, depending on the optical requirements of the cameras and artificial reality system. The location of each region can be positioned anywhere on the lens as well.

In addition, an artificial reality device can comprise one or more cameras or laser emitters behind each lens region. The lens, which can be a colored lens, can affect operations by the device, such as displaying images, executing location functions, and general operations on a virtual reality device.

In various embodiments, the coating, such as a colored coating, comprises a plurality of regions each comprising a color profile. The color profiles selectively transmit light and can comprise on-axis and off-axis color profiles that transmit light differently, based on the angle of transmission through the lens.

In embodiments, one or more cameras positioned behind each lens region receives transmitted light. A computing system, comprising a processor and non-transitory memory comprising computer-executable instructions, operates with the camera, to receive information associated with the received light wavelengths, determine a color calibration, and update the received information to perform one or more operations. In various embodiments, such operations can be artificial reality functions.

In embodiments, the processor and memory can comprise instructions that receive light one or more cameras. The received light can provide environmental information, such as scene information, that can be usable to execute one or more operations on the device. Since the color profiles are known, the computing system can identify, among other things, wavelengths of light reflected by the color profile positioned in front of each camera. The computing system can further determine a color calibration based on the known color profile. In examples, as discussed herein, the color calibration amplifies wavelengths of light reflected by the color profile. The computing system can then update environmental information obtained from the received light, based on the color calibration. The device can then execute one or more operations based on updated environmental information.

In various embodiments, the executed operation can be a display and/or projection of the environmental information via one or more light emitting devices. The display can occur on a plurality of display devices, such as a monitor, external display, mobile device, AR/VR headset, and the like. In other embodiments, the operation can relate to one or more functions of an AR device, such as a user interaction, processing of visual data, simultaneous location and mapping (SLAM) functions, capturing a picture, obtaining environmental information, or emitting light, e.g., through a laser emitter, light emitting diode (LED), etc., through the lens, and any of a plurality of features and functions utilizing the received light.

In various embodiments, as illustrated in FIG. 1, a lens can comprise a plurality of first regions 130a, 130b optimized to receive wavelengths in the visible spectrum. The first regions can be symmetrically positioned on the lens. One or more first regions 120 (i.e., optimizing visible spectrum wavelengths) can be centrally placed on the lens. In embodiments, regions optimized for visible wavelengths can be placed beneath a second region optimized in the infrared spectrum 110.

As illustrated in FIG. 1, two regions 120a, 130b can be placed symmetrically on the lens, with a left region and right region. A third region 120 can be placed centrally, and equidistant from regions 130a, 130b. In embodiments, the third region 120 is positioned above regions 130a, 130b. Regions 130a, 130b, and 120 can be optimized for visible spectrum wavelengths. In some embodiments, regions 130a, 130b comprise a color profile to optimize received light for high resolution SLAM operations. Such color profiles for regions 130a, 130b can be the same or different. Region 120 can optimize wavelengths for receipt at a camera, such as an RGB camera or a visible spectrum camera, which in embodiments, can be placed directly behind region 120. The centralized placement of region 120 and any camera hardware behind the region 120 enhances environmental information, e.g., scene information obtained by the camera. In devices such as head gear, glasses, and associated AR/VR devices, such positioning can be particularly useful in capturing images reflective of the view of a user wearing the device.

In some embodiments, a lens can further include at least one region 110 optimized to enhance operations utilizing infrared light. Like region 120, region 110 can be centrally positioned. In embodiments, region 110 can be placed above other regions, e.g., regions 130a, 130b, 120. Moreover, one or more hardware devices, such a camera and/or laser emitter can be positioned behind region 110. A camera behind infrared region 110 can receive light filtered by the color profile of region 110. A laser emitter behind infrared region 110 can emit light through region 110. In any or all cases, a computing system associated with the lens and associated hardware devices can enhance, tune, and/or optimize operations associated with light being received and/or emitted through the color profiles of each region 110, 120, 130a, 130b on the lens.

It will be appreciated that the position of the various regions can be adjusted based on the particular camera, emitter, and/or computing system components behind the lens. For example, visible wavelength regions 130a, 130b can be tuned to enhance operations utilizing visible wavelengths. Such regions 130a, 130b can further enhance user experience and visibility through a placement in front of a line of sight of the user and providing greater transmission of wavelengths within the visible realm.

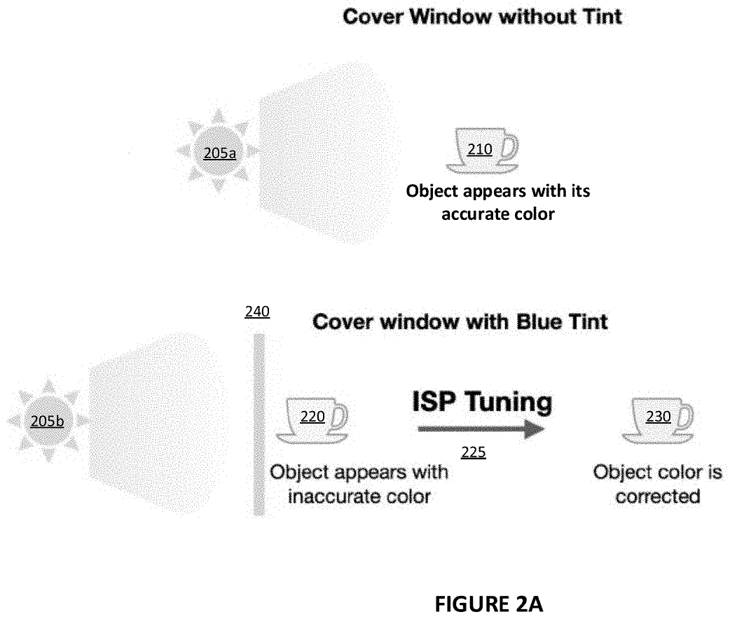

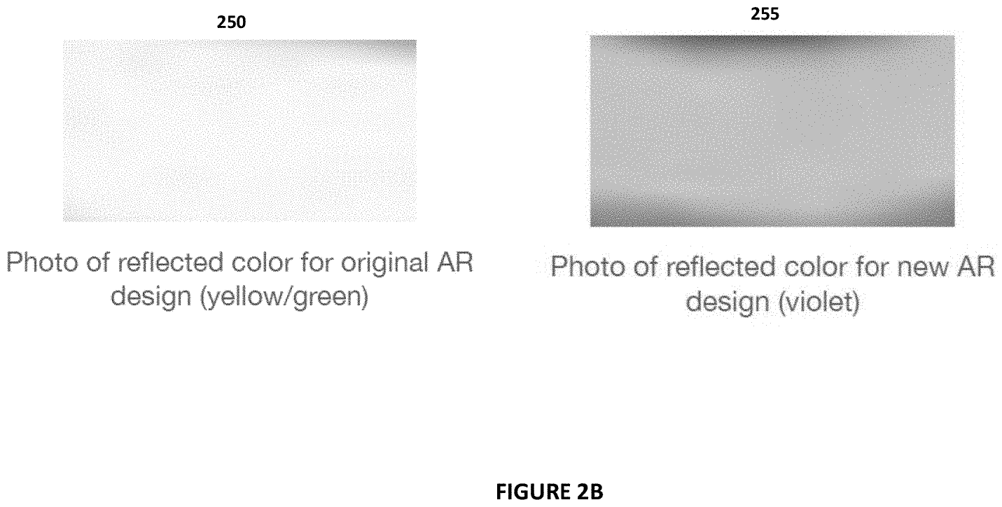

FIG. 2A illustrates an overview of color correction operation, executable by one or more computing systems utilizing light filtered through lenses comprising a coating with a plurality of color regions. FIG. 2B illustrates two different colors resulting from embodiments of the color tuning process discussed herein. A first AR design 250 provides a yellow/green reflected color. A second AR design 255 provides a violet color.

In a system utilizing a lens or cover window without a tint, such as a clear lens, and/or in systems that do not utilize any lens or cover window, light 205a traveling through does not change. To a camera or other light receiving device behind the lens or cover window, the object 210 appears with its natural color. In other words, the lens or cover window does not filter, distort, or otherwise alter the appearance of the object 210.

However, in a system utilizing a colored window 240, such as a lens with a blue tint, light 205b traveling through the colored window 240 becomes distorted, as the colored window selectively reflects certain wavelengths of light and transmits other wavelengths of light. An object 220 viewed through the colored window 240 becomes distorted and can appear to have an inaccurate color. In one example, if the object is a white cup, viewing the object through a blue-tinted lens can make the object appear blue.

To correct this color distortion, image signal processing (ISP) tuning 225 can compensate for the impact of the colored window 240. In embodiments, the ISP tuning 225 provides a color calibration and/or white balance adjustment to compensate for the known color distortion caused by the colored window 240. A computing device in communication with the one or more cameras or light receptors receiving the filtered light can apply ISP tuning 225 techniques to color correct the object 230. Continuing the above example, the lens reflects blue light causing the user to see a blue tint. The camera behind the colored window 240 accordingly receives less transmitted blue light, and needs to color correct for the discrepancy, since the object's color became distorted from the colored window 240. The ISP tuning 225 can color correct this distortion to account for the blue color profile of the colored window, and cause the object to appear white, i.e., its natural color.

As discussed herein, many AR/VR devices and headsets utilize a plurality of cameras behind the lens, and execute operations based on the images received. The images are often reflective of environmental information, such as the scene a user sees through the lens. Since the received images typically serve as the foundation for many operations on the artificial reality device, it is essential that the computing system and its processor accurately identify and detect the view through the lens. Accordingly, the ISP tuning operations 225 help ensure that the received light is color corrected, based on the color profile of the lens in front of the camera and/or light receptor device. By knowing the color profile in front of the cameras and/or light receptor device and having the ability to tune and color correct the received light, devices and systems can effectively and accurately function despite the color of the lens. This enables a plurality of lens colors, designs, and configurations, that could not previously be implemented, due to color distortions and inaccuracies caused by filtered light.

Moreover, such systems, methods, and devices can be applied to windows comprising a variety of shapes and sizes, such as flat lenses, curved lenses, and other 2D and 3D lens shapes.

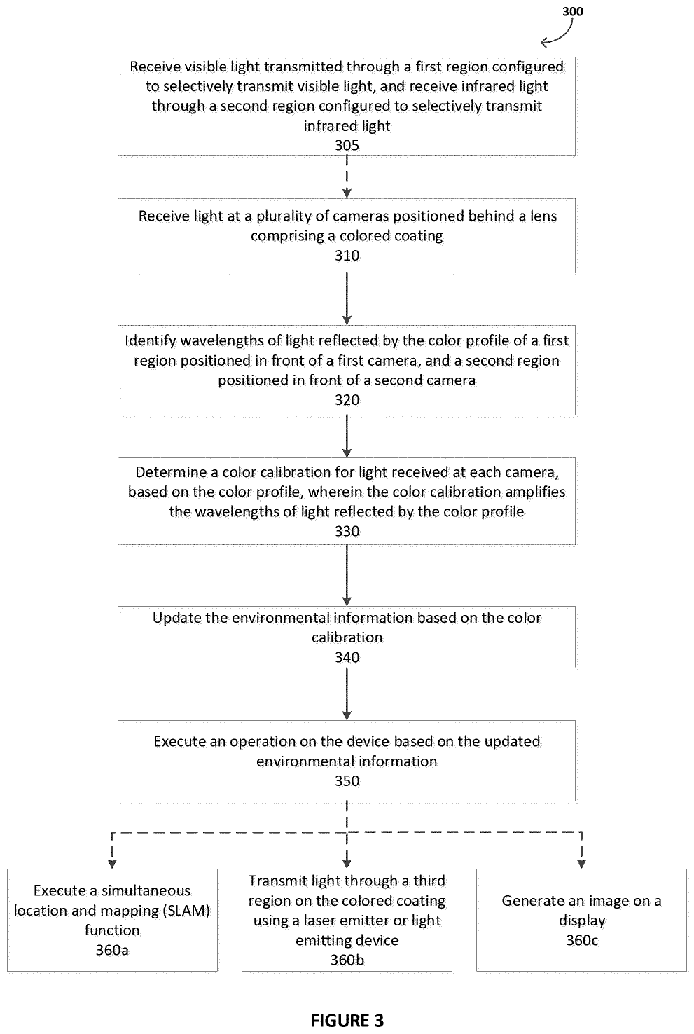

FIG. 3 illustrates an example flowchart illustrating example methods for executing color calibrations and associated operations 300 in accordance with exemplary embodiments discussed herein. Such methods can be applied on various systems and devices, such as AR/VR devices, headsets, and one or more computing devices, as discussed herein.

Various embodiments can utilize colored lenses comprising one or more regions comprising a color profile. In embodiments comprising a plurality of regions, two or more regions can have the same or different color profiles. Any of a variety of lens designs and color profiles can be utilized in accordance with embodiments.

In embodiments, a system can receive visible light transmitted through a first region configured to selectively transmit visible light and receive infrared light through a second region configured to selectively transmit infrared light 305. Such regions can be on a colored lens, for example, on an AR/VR headset and/or in accordance with other device embodiments discussed herein. Accordingly, the first region's color profile allows for the selective transmission of visible light and the second region's color profile allows for the selective transmission of infrared light. It will be appreciated that more or less regions can be present on systems, and that the particular color profiles defined in step 305 are but one example.

Regardless of various color profiles and the number of regions, exemplary embodiments receive light at a plurality of cameras positioned behind a lens comprising a color coating 310. The light can be indicative of environmental information, such as scenery, a view through the lens, and the like.

In embodiments, received light provides environmental information for executing an operation on the device. In one example, on an artificial reality headset, cameras positioned behind the lens can execute an operation to capture an image intended to reflect a snapshot of the environment beyond the lens. Since the colored lens and the regions in front of the camera distort the light, a color calibration, based on the color profile of the region in front of the camera, can help generate an image with realistic colors (see, e.g., FIG. 2A).

When light is first received at the plurality of cameras 310, systems can further identify wavelengths of light reflected by the color profile of a first region positioned in front of a first camera and a second region positioned in front of a second camera 320. In various embodiments, one or more cameras can be positioned behind a region, and the colored lens can comprise a plurality of regions. The design of the lens, with regard to placement and number of regions can vary based on the system's purpose, function, use, and design, among other factors.

The color calibration for light received at each camera can be based on the color profile of the region through which the light travels. A color profile can further comprise a transmission profile and a reflection profile, indicative of wavelengths selectively transmitted and reflected, respectively. In an example, in a region having a color profile tuned to selectively transmit visible light, a computing system can calibrate the received light information based on the wavelengths filtered, reflected, and/or transmitted.

In particular, systems and methods determine a color calibration for light received at each camera based on the color profile, wherein the color calibration amplifies. wavelengths of light reflected by the color profile 330. For example, a color profile can comprise a reflection profile, indicative of wavelengths that are reflected. In embodiments, reflection profiles can indicate a percentage, ratio, or other indication of an amount of light reflected per wavelength and/or wavelength range. Similarly, embodiments can utilize reflection profiles associated with the color profile to assist in the determination of the color calibration, and determination of wavelengths of light for amplification.

Systems and methods can further update the environmental information based on the color calibration 340. As discussed herein, the environmental information can be indicative of a view through the lens, from the perspective of a user or other viewer or viewing device. In other examples, environmental information can comprise one or more objects, colors, and features. Systems and methods execute one or more operations on the device based on the updated environmental information 350.

An example of an operation can be an execution of a simultaneous location and mapping (SLAM) function 360a. Other possible operations include light transmission through the colored coating 360b. Such light transmissions can utilize one or more of a laser emitter, a light emitting diode (LED), or other light emitting device. An operation can comprise generating, projecting, and/or displaying an image on a display 360c. The display can be, for example, one or more monitors, computing devices, screens, mobile devices in communication with the devices and computing systems utilized herein. Tracking operations, auto-focus, and AR/VR functions, among many other operations can utilize environmental information.

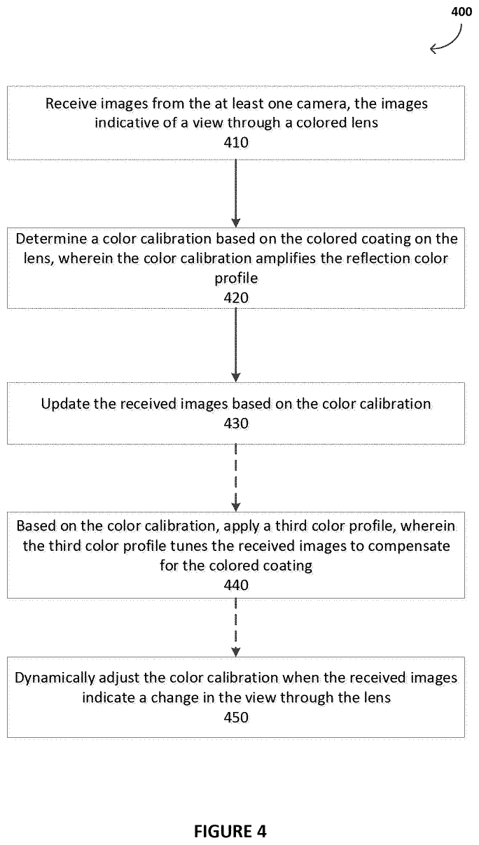

FIG. 4 illustrates another exemplary method for executing color calibration operations 400 in accordance with embodiments. Similar to FIG. 3 and other examples discussed herein, the color calibration 400 can operate on artificial reality devices, headsets, and related computing systems. Such systems receive images from at least one camera, wherein the images are indicative of a view through a lens 410. Such cameras can be placed behind a lens, such as in an AR/VR device. As discussed herein, the camera can serve to identify environmental information, and provide an outward facing view of a view, such as a scenery view, similar to that which a user views when using the device and looking through the lens.

Systems and devices can determine a color calibration based on the colored coating 420. The color calibration amplifies a reflection color profile associated with the colored coating. Systems and devices update received images based on the color calibration.

In certain embodiments, based on the color calibration, a third color profile can be applied to received images to tune the view through the lens and compensate for the colored coating 440. The color calibration can dynamically adjust the color calibration when the received images indicate a change in the view through the lens 450.

Such operations can be helpful when utilizing the received images for one or more operations, as discussed herein. In an example, the view through the lens, as observed by the one or more cameras, may be displayed on one or more displays, such as a local display, on a backside of the colored lens, or on one or more external devices. Since the cameras view through the lens becomes distorted based on the colored coating on the lens, the colored calibration amplifies the reflected wavelengths, to compensate for the effect of the colored coating. Such operations aid in generating accurate images with realistic colors, despite colored coatings. Such operations further enable various colored coatings and designs to be applied onto devices, without affecting the function and operation of the device, e.g., AR/VR devices.

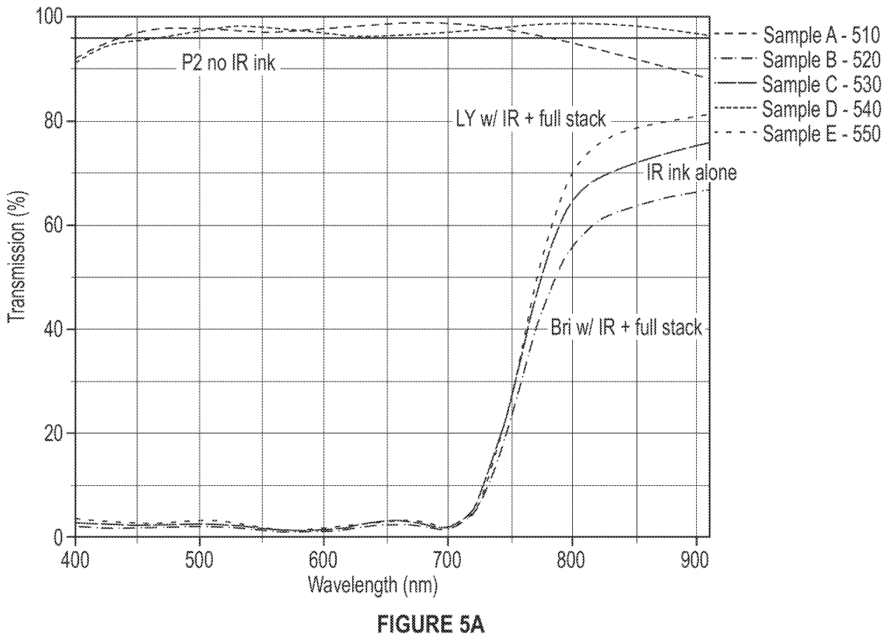

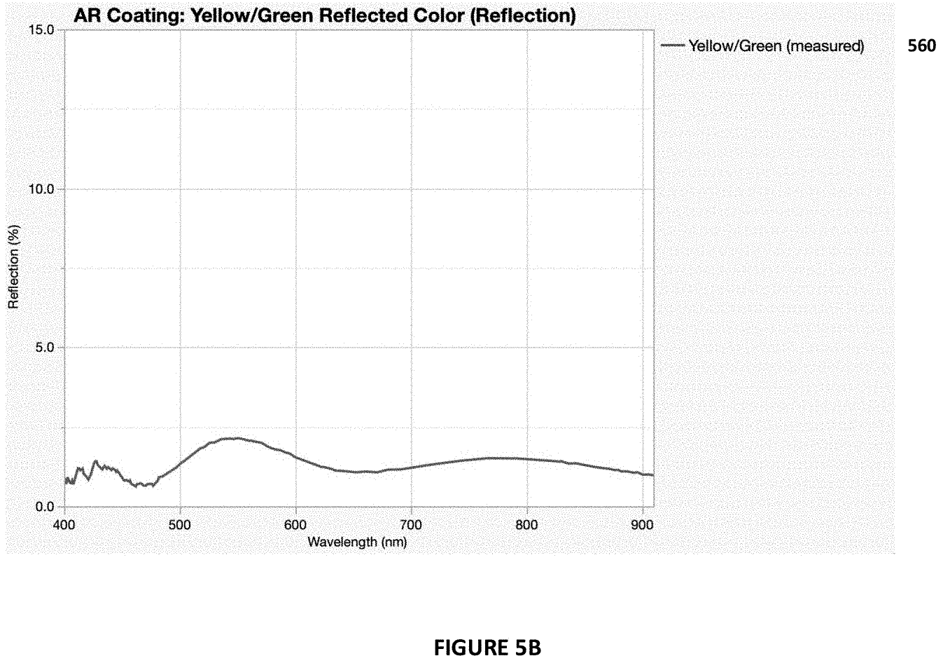

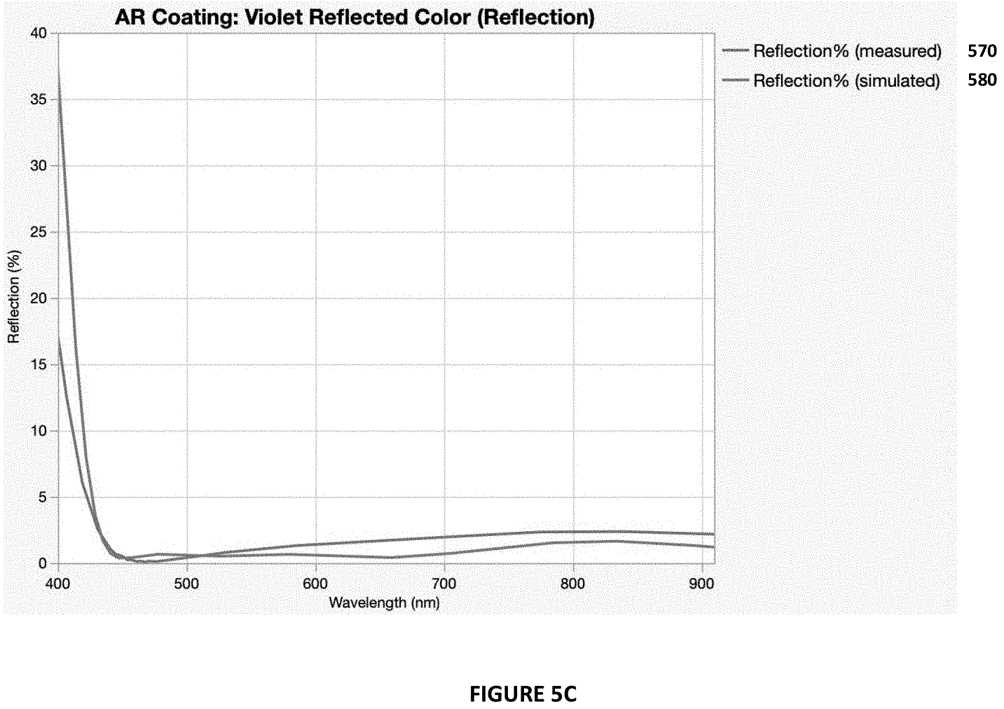

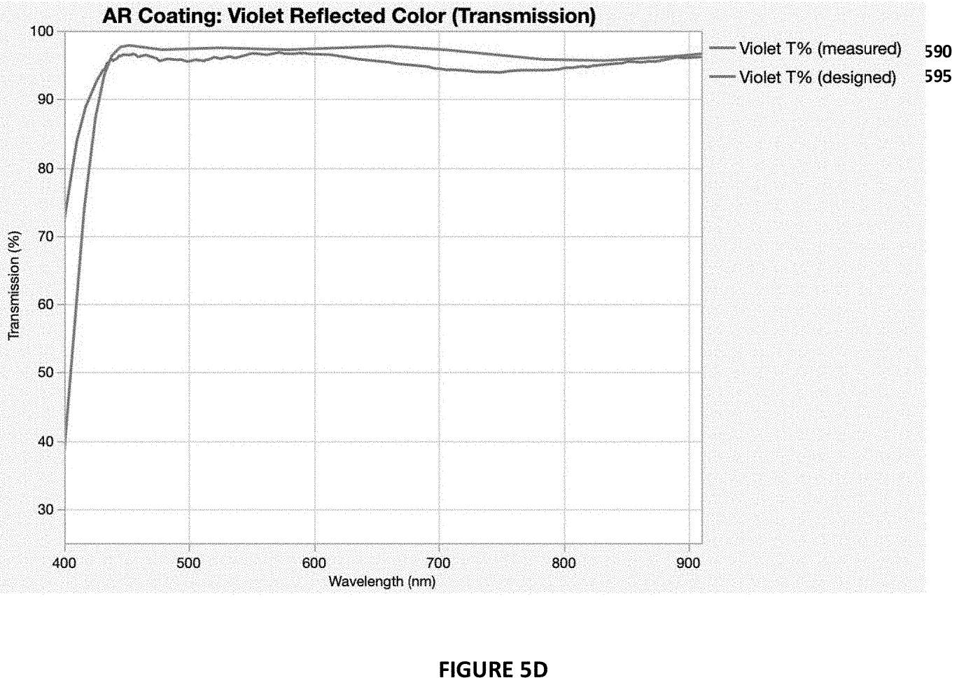

FIG. 5A illustrates an example transmission vs. wavelength graph for various coatings on a lens, usable for various embodiments discussed herein. The graph compares various lenses and demonstrates a stark difference between light transmission through lenses without any coatings and configurations with specialized infrared ink coatings. Lenses with coatings utilized infrared ink. Transmission data for each lens utilized a 0° angle of incidence (AOI) during testing. This transmission data, with a 0° AOI, provides examples for on-axis color profiles.

The two lenses without any infrared ink coating, corresponding to the curves for Sample A 510 and Sample B 540, demonstrated a consistent transmission rate of over 90% for wavelengths between 400 nm and 900 nm. The lens corresponding to curve for Sample C 530 may include infrared ink on polycarbonate/polymethylmethacrylate (PC/PMMA). In other embodiments, the Sample may include any such ink and substrate combination, such as an ink and transparent polymer combination. For the three curves relating to lenses with infrared coating, i.e., Sample B 520, Sample C 530, and Sample D 550, the lenses have a less than 20% transmission rate for wavelengths below 750 nm, and less than 10% transmission rate for wavelengths below 730 nm. Above 850 nm, transmission rates increase to at least 60%. In some examples, as with the curve for Sample E 550, transmission rates can increase to 70% or greater for wavelengths of 800 nm and above. While the tested coatings demonstrate transmission rates for infrared inks, it will be appreciated that various types of coatings, directed toward particular wavelengths can be applied in a similar manner. Likewise, such coatings can include discrete regions on a lens, as discussed herein, and such transmission data can be applicable for determining color profiles, transmission profiles, and reflection profiles for such regions.

FIG. 5B illustrates an example reflection (%) versus wavelength (nm) graph for an AR coating related to a yellow/green reflected color. The reflection percentage of yellow/green indicates a peak refection of around 1-2.5% for wavelengths between 500-600 nm, with a peak of about 2.4% at approximately 550 nm. Secondary peaks occur between 400-500 nm, and between 400-450 nm. Another smaller peak occurs around 750-800 nm. The reflected wavelength peaks result in a yellow/green reflected color.

FIG. 5C illustrates another example reflection (%) versus wavelength (nm) graph for an AR coating, but related to a violet reflected color. Both the measured reflection percentage, represented by line 570, and the simulated reflection percentage, represented by line 580, demonstrates a sharp decrease between 400-450 nm. The illustrated design exhibits a strong reflection at 400 nm, which corresponds to violet reflected light. After approximately 450 nm, both the simulated and measured examples do not exhibit a reflection percentage greater than about 2.5%.

FIG. 5D illustrates an example transmission (%) versus wavelength (nm) graph for an AR coating related to the violet reflected color. Both the measured transmission percentage, represented by line 590, and the simulated reflection percentage, represented by line 595, demonstrates a sharp increase between 400-450 nm. After approximately 450 nm, both the simulated and measured examples do not exhibit a reflection percentage less than about 95%. The transmission curves for the violet reflected colors have a lower transmission percentage at lower wavelengths. The ISP tuning mechanisms and embodiments discussed herein can account for this loss in transmission.

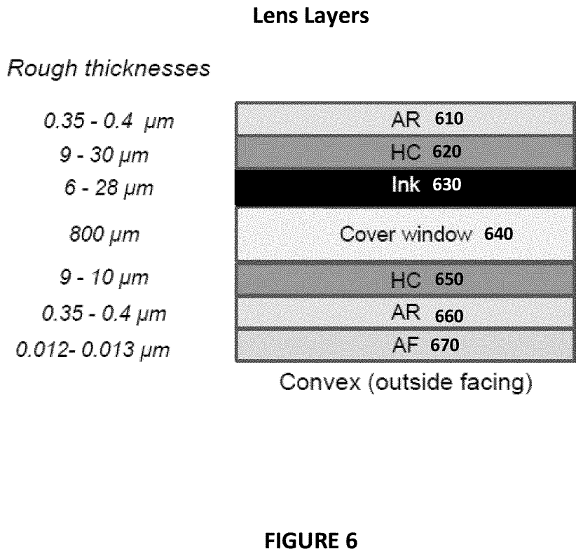

FIG. 6 illustrates an example material stack for lenses and coatings as discussed herein. A lens, such as a colored lens, can comprise a plurality of layered materials. Such materials can be stacked on an inner and outer sides of a cover window 640. In embodiments, such materials can comprise PC, PMMA, a combination of PC/PMMA, and the like. The layered materials can include, but are not limited to, an ink layer, a hard-coat (HC) layer, and an outer anti-reflective (AR) layer. In some embodiments, an anti-fingerprint (AF) layer can be applied to the outermost layer.

In embodiments the lens can be a curved lens, such that an outer portion comprises a convex shape. In the example illustrated in FIG. 6 a lens can comprise an AR layer 610 can comprise an innermost layer 0.35-0.4 micrometers thick, an HC layer 620 with a 9-30 micrometer thickness, an ink layer 630 with a 6-28 micrometer thickness, an ˜800 micrometer cover window 640 (e.g., PC/PMMA, PC, etc.), another HC layer 650 with a 9-10 micrometer thickness, another AR layer 660 with a 0.35-0.40 micrometer thickness, and an outer AF layer 670 with a 0.012-0.013 micrometer thickness.

It will be appreciated that lens designs can comprise more or less material layers than illustrated in FIG. 6, and the layer thicknesses may be greater or less, depending on the desired optical characteristics of the lenses. In addition, such layers can extend over part or all of a lens, and various layer combinations and layer thicknesses can be implemented to form one or more regions on a lens. In other words, various regions on a lens can comprise similar or different layer configurations, and FIG. 6 provides only one such example for generating a lens in accordance with embodiments discussed herein.

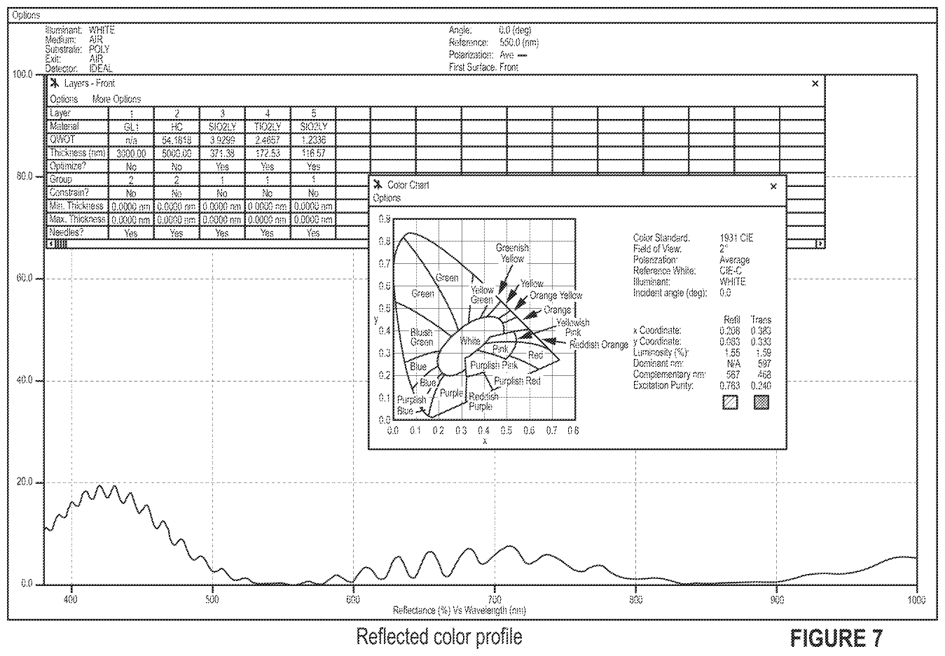

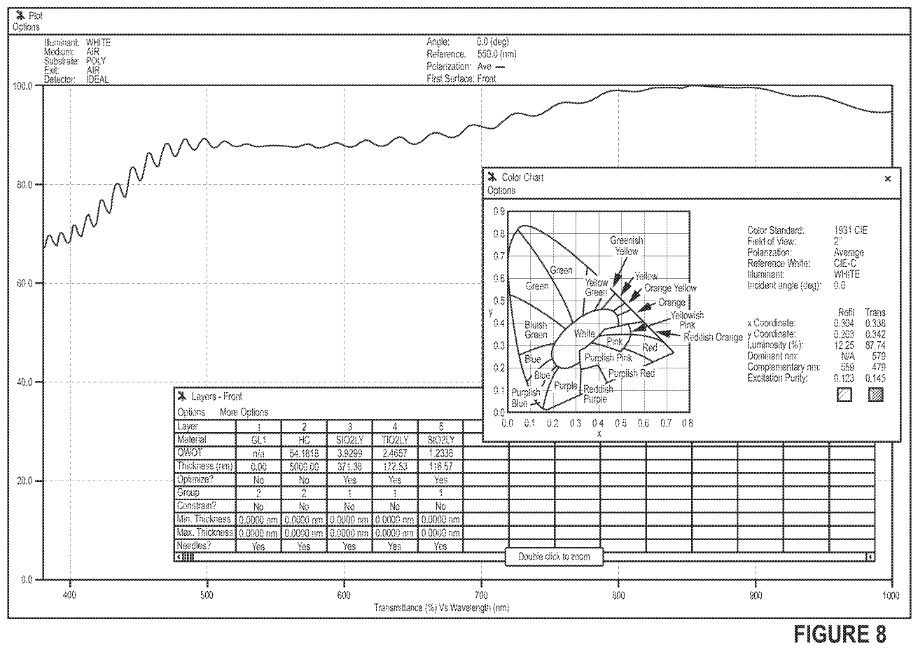

FIG. 7 illustrates an example reflection profile, and FIG. 8 illustrates a corresponding transmission profile. As discussed herein, lenses can be tuned to reflect particular color(s) in certain regions, e.g., non camera regions, and optimized to transmit known colors. Systems and methods can execute calibration operations based on the known reflection profiles and transmission profiles to optimize camera performance, and any operations utilizing the images received the camera.

FIG. 7 provides reflection (%) vs. wavelength (nm) from approximately 400 nm to 1000 nm for an example reflection profile in accordance with embodiments. FIG. 7 illustrates significant reflection for light in the 400-500 nm range and peaking at approximately 20%. Light in the 600-800 nm wavelength range also experience increased reflection, peaking at around 10%. Wavelengths greater than 900 nm are reflected as well, peaking at approximately 5%. The lowest reflection levels are seen between 500-600 nm and 800-900 nm, with less than 5% reflection. Reflection is near zero around 530-570 nm and 830-900 nm, and at a minimum around 550 nm and 830-840 nm.

FIG. 8 illustrates a corresponding transmission profile to the reflection profile of FIG. 7, in accordance with embodiments. The example transmission profile provides transmission (%) vs. wavelength (nm) data. Wavelengths above 500 nm transmit light at levels approximately 88% and higher, peaking around 100% transmission around 800-900 nm. Light in the 400-500 nm range experience lower transmission levels, as expected, since this range experienced the greatest reflection levels in FIG. 7. The transmission levels of 400-500 nm light increase as the wavelengths increase, starting at approximately 68% at 400 nm, and reaching approximately 88% transmission at 500 nm. Light in the 500-600 nm wavelength remains constant at approximately 88-90% transmission and being to increase after 600 nm. Light in the 700-900 nm range increases and peaks at around 100% transmission between 800-900 nm, and decreases slightly, above 900 nm.

Table 1 illustrates data related to transmission profiles for a plurality of lens types and colors, ranging from green, red, blue, clear, and combinations of such colors. The following table provides transmission spectra data for various lens configurations and examples. Transmission profiles, comprising transmission data for a plurality of wavelengths and/or ranges of wavelengths, can provide a basis for color calibration operations. The coloration discussed in the following table is relevant to custom ink meant for near-infrared usage.

TABLE 1

| | | 2 | 3 | | | | | | 9 |
|---|---|---|---|---|---|---|---|---|---|
| | | Green/ | Green/ | | 5 | | 7 | 8 | Green/ |
| | 1 | Clear | Clear | 4 | Red/ | 6 | Blue/ | Green/ | Red/ |
| Color | Green | A | B | Red | Clear | Blue | Clear | Red | Clear |
| T % | 91.4014 | 90.8532 | 91.6532 | 91.2415 | 91.7397 | 89.1285 | 90.8275 | 90.3015 | 92.1005 |
| 940 nm | | | | | | | | | |
| T % | 89.8806 | 91.2004 | 90.5094 | 89.9659 | 90.6843 | 86.1239 | 88.836 | 89.3295 | 91.3765 |
| 850 nm | | | | | | | | | |
| T % | 0.5453 | 7.5548 | 10.6507 | 0.0101 | 7.7763 | 0.7312 | 7.5656 | 0.1692 | 10.8715 |
| 550 nm | | | | | | | | | |

As discussed above, embodiments of the present invention comprise lenses having one or more regions, with each region comprising one or more color profiles. A particular region can comprise differing on-axis and off-axis color profiles, each with a transmission profile and a reflection profile. On-axis and off-axis refer to the angle of incidence (AOI) of light received at a particular region. On-axis indicates light received directly, with little to no AOI, while off-axis indicates light received at an angle. Different color profiles can exist for different AOIs and/or ranges of AOIs.

Table 2 illustrates specific transmission requirements for embodiments of camera regions as a function of wavelength. With respect to Table 2, camera regions represent lens regions, e.g., on a lens of an artificial reality device, behind a camera is positioned and receives light. Based on camera needs for optimal functionality, minimum transmission requirements can optimize one or more cameras. Table 2 indicates specific requirements for on-axis and off-axis, e.g., 70-degree AOI, for ranges of wavelengths.

In embodiments, an on-axis color profile can transmit over 77% of light between 400-860 nm, with the greatest transmission between 500-700 nm. An off-axis color profile wherein the on-axis color profile for at least one region has greater than a 90% transmission rate for wavelengths above 500 nm. An on-axis color profile for at least one region on a lens provides over 96% transmission rate for wavelengths between 500-700 nm. Off-axis color profile in embodiments can comprise a transmission rate of greater than 64% for wavelengths above 500 nm and/or a transmission rate of greater than 73% for wavelengths between 500-700 nm.

TABLE 2

| | |
|---|---|
| Wavelength | Camera Regions |

| | | | |
|---|---|---|---|
| T % at 0 degrees | 400 | nm | >77% |
| | 500 | nm | >96% |
| | 600 | nm | >96% |
| | 700 | nm | >97% |
| | 840-860 | nm | >90% |
| T % at 70 degrees | 400 | nm | >59% |
| | 500 | nm | >74% |
| | 600 | nm | >73% |
| | 700 | nm | >74% |
| | 840-860 | nm | >64% |

Table 3 illustrates color calibration data utilizing on-axis and off-axis color profile information for a blue colored lens. The color calibration identifies the signal to noise ratio (SNR) for red (R), green (G), blue (B), and yellow (Y) wavelengths, both on-axis and off axis, with regard to a point of reference (Cool White, CW) and Blue. The delta values for the on-axis measurements indicate a drop in SNR which can be compensated during a color calibration operation. The delta values for the off-axis measurements indicate an SNR enhancement which can also be compensated during color calibration operations. It will be appreciated that while SNR can serve as a basis for color calibration operations discussed herein, they are but one example of color profile data and measurements applicable for color calibration operations. Exemplary embodiments can utilize other measurements and values instead of or in addition to the SNR measurements, and each are in accordance with the various embodiments discussed herein.

TABLE 3

| | On-Axis | | | Off-Axis | | |
|---|---|---|---|---|---|---|
| | Point of | | | Point of | | |
| | Reference | | Delta | Reference | | Delta |
| | (CW) | Blue | % | (CW) | Blue | % |
| Red | 11.79 | 10.83 | −8.1% | 5.95 | 6.99 | 17.5% |
| Green | 12.90 | 11.88 | −7.9% | 7.89 | 9.01 | 14.2% |
| Blue | 3.98 | 3.77 | −5.3% | 2.49 | 2.83 | 13.7% |
| Yellow | 11.55 | 10.64 | −7.9% | 6.69 | 7.70 | 15.1% |

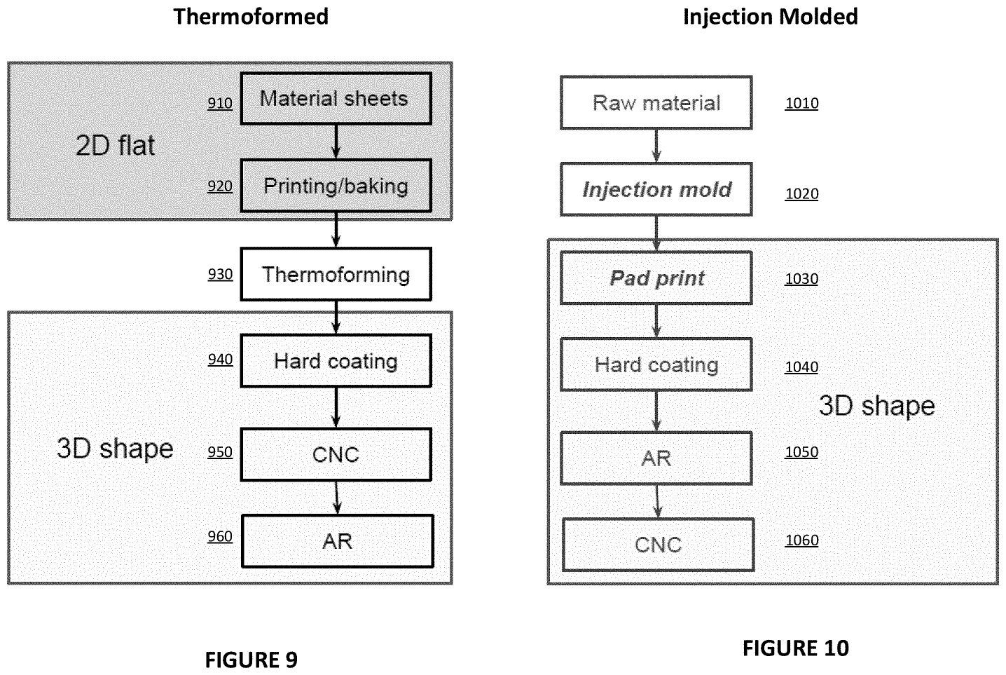

FIGS. 9-10 illustrate various color tinting fabrication processes applicable to embodiments of the present invention. Such processes can generate lenses, such as the layered device illustrated in FIG. 6. FIG. 9 illustrates a thermoform process to create 2D and 3D lenses. In the thermoform method, material sheets 910, e.g., lens material, PC, PC/PMMA, etc., can be printed and/or baked 920 to create a two-dimensional flat lens. Thermoforming 930 heats the lens to a forming temperature to allow the product to be molded into a three-dimensional shape. A hard coating 940 can be applied to the thermoformed product, and trimming process, such a computer-numerical-controlled (CNC) operation 950, can shape the product into the desired form. Additional layers and/or coatings, such as an anti-reflective (AR) layer 960 can be applied to the product. A thermoforming process generate products and lenses in accordance with embodiments, having one or more regions with particular optical characteristics and color profiles.

FIG. 10 provides a flow chart for an injection molding process to form three-dimensional products, devices, and lenses, in accordance with embodiments. Raw material 1010, such as polyethylene, polycarbonate, and/or PMMA material can be injection molded 1020 to form a 3D shape. In the injection molding process, raw material 1010 can be heated into a molten form, then injected into a mold, and cooled while in the mold. Pad printing operations 1030 can add additional colors, materials, and/or designs to the product. In an example, the lens can be colored with regions having color profiles. A hard coating 1040 can be applied to the product, along with an anti-reflective (AR) layer 1050. A trimming process, such as a CNC operation 1060, can further refine the product to its desired shape and size. Similar to thermoforming processes, injection molding processes can generate products and lenses in accordance with embodiments, having one or more regions with particular optical characteristics and color profiles.

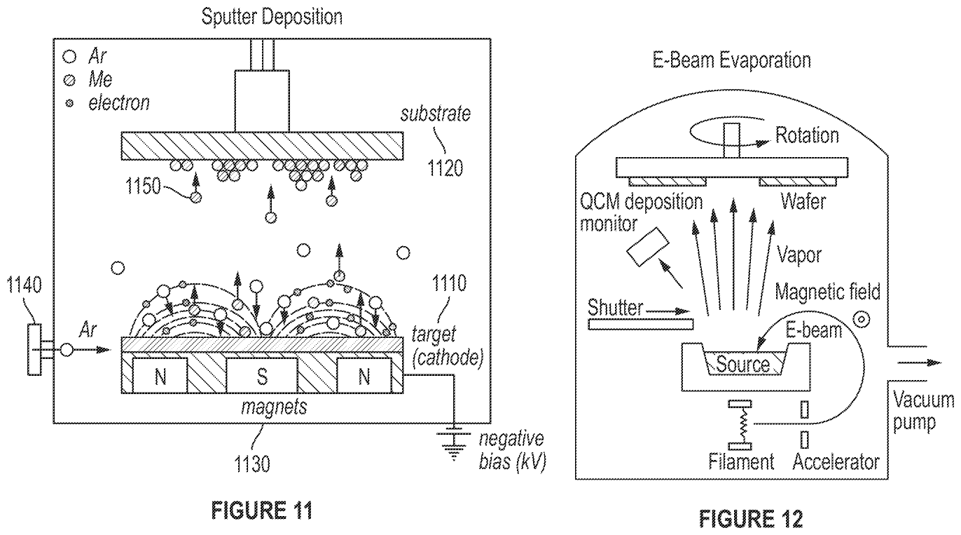

FIGS. 11-12 illustrate apparatuses for various film coating methods, usable to create colored lenses for embodiments of the present invention. Various processing methods utilize physical vapor deposition (PVD) for coating products and devices, such as the lenses discussed herein. FIG. 11 illustrates a sputter deposition apparatus in accordance with embodiments. In a sputter deposition coating process, a target cathode 1110 is secured to one or more magnets 1130, and electrically charged 1140 to cause material 1150 to eject from the target cathode 1110 and transfer to a substrate 1120. The substrate can be a lens or other desired device to be coated. The sputtering process is advantageous for providing a strong, unform coating on the substrate surface. Sputtering further enables deposition of a variety of materials, and a plurality of layers with desired thicknesses, as in various embodiments discussed herein.

FIG. 12 illustrates an Electron-Beam (E-Beam) Evaporation apparatus in accordance with embodiments. In an E-Beam Evaporation process, an apparatus comprising a filament, accelerator, magnetic field, shutter, and vacuum pump, generates an electron beam directed toward a target material source. The interaction causes target material to evaporate and convert into a gaseous vapor state, where it can be deposited onto a substrate, such as a lens or other device to be coated. One or more sensors, such as a quartz crystal microbalance (QCM) sensor can analyze the thickness of the deposited target material in real-time, thus enabling precise and accurate layers.

It will be appreciated that while PVD processing methods can form products, devices, and lenses in accordance with embodiments, formation of such embodiments are not limited to such processing methods. A plurality of processing methods, systems, devices, and apparatuses can generate one or more layers and aspects of products and devices in accordance with embodiments.

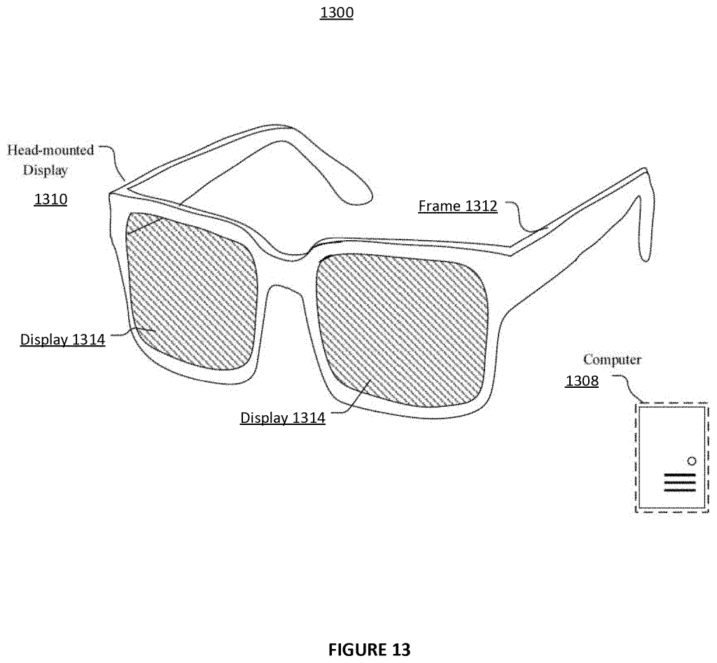

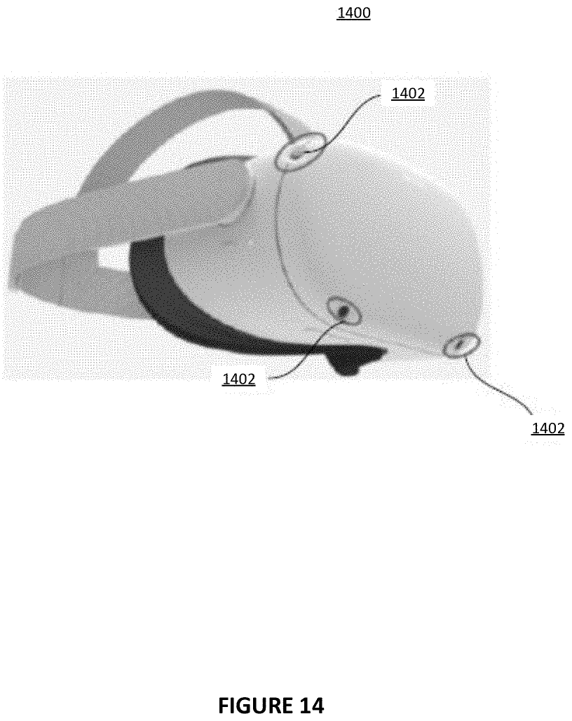

FIG. 13 illustrates an example artificial reality system 1300. The artificial reality system 1300 may include a head-mounted display (HMD) 1310 (e.g., glasses) comprising a frame 1312, one or more displays 1314, and a computing device 1308 (also referred to herein as computer 1308). The displays 1314 may be transparent or translucent allowing a user wearing the HMD 1310 to look through the displays 1314 to see the real world and displaying visual artificial reality content to the user at the same time. The HMD 1310 may include an audio device 1306 (e.g., speaker/microphone 38 of FIG. 6) that may provide audio artificial reality content to users. The HMD 1310 may include one or more cameras 1316 which can capture images and videos of environments. The HMD 1310 may include an eye tracking system to track the vergence movement of the user wearing the HMD 1310. In one example embodiment, the camera 1316 may be the eye tracking system. The HMD 1310 may include a microphone of the audio device 1306 to capture voice input from the user. The augmented reality system 1300 may further include a controller 1318 (e.g., processor 32 of FIG. 14) comprising a trackpad and one or more buttons. The controller may receive inputs from users and relay the inputs to the computing device 1308. The controller may also provide haptic feedback to users. The computing device 1308 may be connected to the HMD 1310 and the controller through cables or wireless connections. The computing device 1308 may control the HMD 1310 and the controller to provide the augmented reality content to and receive inputs from one or more users. In some example embodiments, the controller 1318 may be a standalone controller or integrated within the HMD 1310. The computing device 1308 may be a standalone host computer device, an on-board computer device integrated with the HMD 1310, a mobile device, or any other hardware platform capable of providing artificial reality content to and receiving inputs from users. In some exemplary embodiments, HMD 1310 may include an artificial reality system/virtual reality system (e.g., artificial reality system 100).

FIG. 14 illustrates another example of an artificial reality system including a head-mounted display (HMD) 1400, image sensors 1402 mounted to (e.g., extending from) HMD 1400, according to at least one exemplary embodiment of the present disclosure. In some embodiments, image sensors 1402 are mounted on and protruding from a surface (e.g., a front surface, a corner surface, etc.) of HMD 1400. In some exemplary embodiments, HMD 1400 may include an artificial reality system/virtual reality system (e.g., artificial reality system 100). In an exemplary embodiment, image sensors 102 may include, but are not limited to, one or more sensors (e.g., camera 1316, a display 1314, an audio device 1306, etc.). In exemplary embodiments, a compressible shock absorbing device may be mounted on image sensors 1402. The shock absorbing device may be configured to substantially maintain the structural integrity of image sensors 1402 in case an impact force is imparted on image sensors 1402. In some embodiments, image sensors 1402 may protrude from a surface (e.g., the front surface) of HMD 1400 so as to increase a field of view of image sensors 1402. In some examples, image sensors 1402 may be pivotally and/or translationally mounted to HMD 100 to pivot image sensors 1402 at a range of angles and/or to allow for translation in multiple directions, in response to an impact. For example, image sensors 1402 may protrude from the front surface of HMD 1400 so as to give image sensors 1402 at least a 180 degree field of view of objects (e.g., a hand, a user, a surrounding real-world environment, etc.).

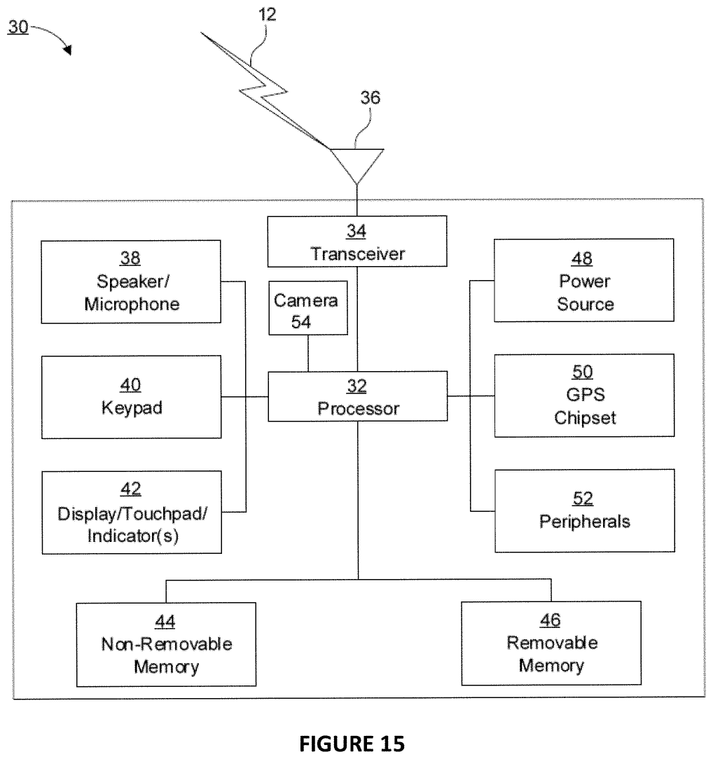

FIG. 15 illustrates a block diagram of an exemplary hardware/software architecture of a UE 30. As shown in FIG. 15, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

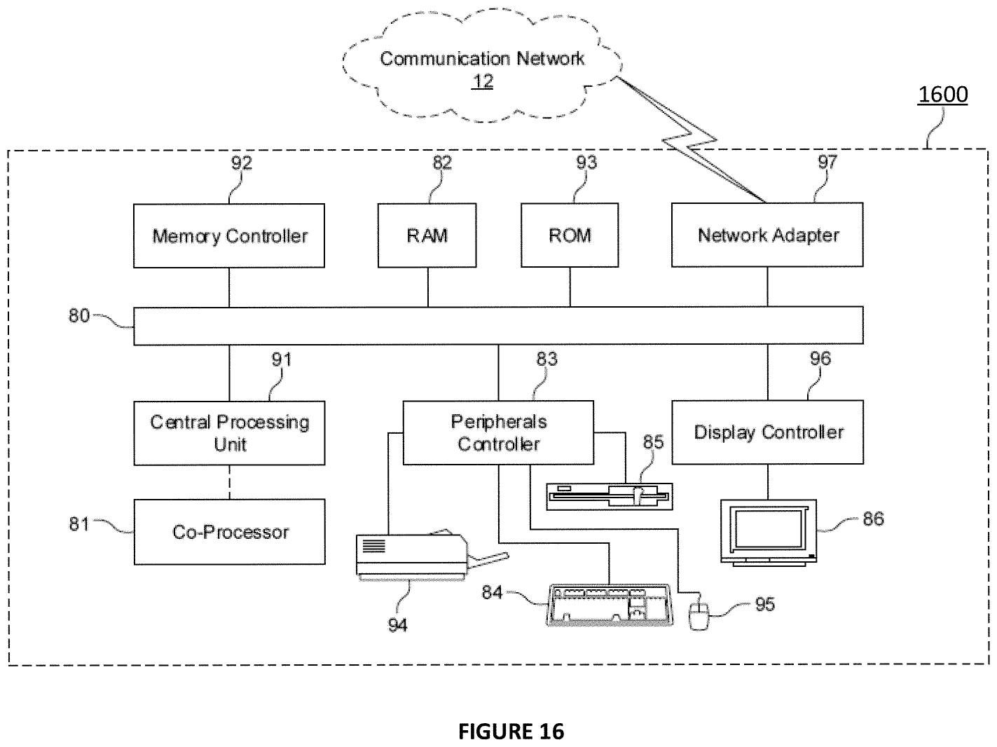

FIG. 16 is a block diagram of an exemplary computing system 1600 which may also be used to implement components of the system or be part of the UE 30. The computing system 1600 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 200 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 200 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 200 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 200. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 1600 may contain communication circuitry, such as for example a network adaptor 97, that may be used to connect computing system 200 to an external communications network, such as network 12 of FIG. 6, to enable the computing system 200 to communicate with other nodes (e.g., UE 30) of the network.

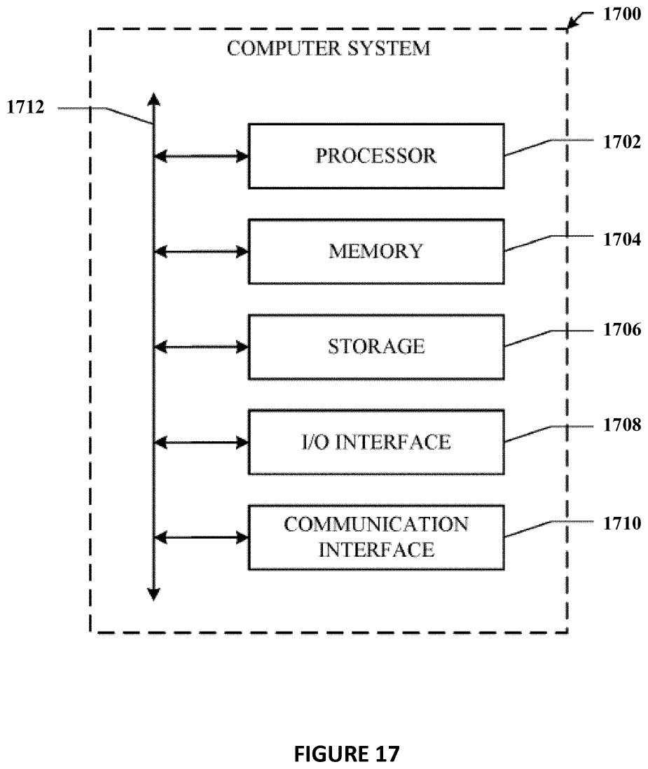

FIG. 17 illustrates an example computer system 1700. In exemplary embodiments, one or more computer systems 1700 perform one or more steps of one or more methods described or illustrated herein. In particular embodiments, one or more computer systems 1700 provide functionality described or illustrated herein. In exemplary embodiments, software running on one or more computer systems 1700 performs one or more steps of one or more methods described or illustrated herein or provides functionality described or illustrated herein. Exemplary embodiments include one or more portions of one or more computer systems 1700. Herein, reference to a computer system may encompass a computing device, and vice versa, where appropriate. Moreover, reference to a computer system may encompass one or more computer systems, where appropriate.

This disclosure contemplates any suitable number of computer systems 1700. This disclosure contemplates computer system 1700 taking any suitable physical form. As example and not by way of limitation, computer system 1700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1700 may include one or more computer systems 1700; be unitary or distributed; span multiple locations; span multiple machines; span multiple data centers; or reside in a cloud, which may include one or more cloud components in one or more networks. Where appropriate, one or more computer systems 1700 may perform without substantial spatial or temporal limitation one or more steps of one or more methods described or illustrated herein. As an example and not by way of limitation, one or more computer systems 1700 may perform in real time or in batch mode one or more steps of one or more methods described or illustrated herein. One or more computer systems 1700 may perform at different times or at different locations one or more steps of one or more methods described or illustrated herein, where appropriate.

In exemplary embodiments, computer system 1700 includes a processor 1702, memory 1704, storage 1706, an input/output (I/O) interface 1708, a communication interface 1710, and a bus 1712. Although this disclosure describes and illustrates a particular computer system having a particular number of particular components in a particular arrangement, this disclosure contemplates any suitable computer system having any suitable number of any suitable components in any suitable arrangement.

In exemplary embodiments, processor 1702 includes hardware for executing instructions, such as those making up a computer program. As an example and not by way of limitation, to execute instructions, processor 1702 may retrieve (or fetch) the instructions from an internal register, an internal cache, memory 1704, or storage 1706; decode and execute them; and then write one or more results to an internal register, an internal cache, memory 1704, or storage 1706. In particular embodiments, processor 1702 may include one or more internal caches for data, instructions, or addresses. This disclosure contemplates processor 1702 including any suitable number of any suitable internal caches, where appropriate. As an example and not by way of limitation, processor 1702 may include one or more instruction caches, one or more data caches, and one or more translation lookaside buffers (TLBs). Instructions in the instruction caches may be copies of instructions in memory 1704 or storage 1706, and the instruction caches may speed up retrieval of those instructions by processor 1702. Data in the data caches may be copies of data in memory 1704 or storage 1706 for instructions executing at processor 1702 to operate on; the results of previous instructions executed at processor 1702 for access by subsequent instructions executing at processor 1702 or for writing to memory 1704 or storage 1706; or other suitable data. The data caches may speed up read or write operations by processor 1702. The TLBs may speed up virtual-address translation for processor 1702. In particular embodiments, processor 1702 may include one or more internal registers for data, instructions, or addresses. This disclosure contemplates processor 1702 including any suitable number of any suitable internal registers, where appropriate. Where appropriate, processor 1702 may include one or more arithmetic logic units (ALUs); be a multi-core processor; or include one or more processors 1702. Although this disclosure describes and illustrates a particular processor, this disclosure contemplates any suitable processor.

In exemplary embodiments, memory 1704 includes main memory for storing instructions for processor 1702 to execute or data for processor 1702 to operate on. As an example and not by way of limitation, computer system 1700 may load instructions from storage 1706 or another source (such as, for example, another computer system 1700) to memory 1704. Processor 1702 may then load the instructions from memory 1704 to an internal register or internal cache. To execute the instructions, processor 1702 may retrieve the instructions from the internal register or internal cache and decode them. During or after execution of the instructions, processor 1702 may write one or more results (which may be intermediate or final results) to the internal register or internal cache. Processor 1702 may then write one or more of those results to memory 1704. In particular embodiments, processor 1702 executes only instructions in one or more internal registers or internal caches or in memory 1704 (as opposed to storage 1706 or elsewhere) and operates only on data in one or more internal registers or internal caches or in memory 1704 (as opposed to storage 1706 or elsewhere). One or more memory buses (which may each include an address bus and a data bus) may couple processor 1702 to memory 1704. Bus 1712 may include one or more memory buses, as described below. In exemplary embodiments, one or more memory management units (MMUs) reside between processor 1702 and memory 1704 and facilitate accesses to memory 1704 requested by processor 1702. In particular embodiments, memory 1704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1704 may include one or more memories 1704, where appropriate. Although this disclosure describes and illustrates particular memory, this disclosure contemplates any suitable memory.

In exemplary embodiments, storage 1706 includes mass storage for data or instructions. As an example and not by way of limitation, storage 1706 may include a hard disk drive (HDD), a floppy disk drive, flash memory, an optical disc, a magneto-optical disc, magnetic tape, or a Universal Serial Bus (USB) drive or a combination of two or more of these. Storage 1706 may include removable or non-removable (or fixed) media, where appropriate. Storage 1706 may be internal or external to computer system 1700, where appropriate. In exemplary embodiments, storage 1706 is non-volatile, solid-state memory. In particular embodiments, storage 1706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1706 taking any suitable physical form. Storage 1706 may include one or more storage control units facilitating communication between processor 1702 and storage 1706, where appropriate. Where appropriate, storage 1706 may include one or more storages 1706. Although this disclosure describes and illustrates particular storage, this disclosure contemplates any suitable storage.

In exemplary embodiments, I/O interface 1708 includes hardware, software, or both, providing one or more interfaces for communication between computer system 1700 and one or more I/O devices. Computer system 1700 may include one or more of these I/O devices, where appropriate. One or more of these I/O devices may enable communication between a person and computer system 1700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1708 for them. Where appropriate, I/O interface 1708 may include one or more device or software drivers enabling processor 1702 to drive one or more of these I/O devices. I/O interface 1708 may include one or more I/O interfaces 1708, where appropriate. Although this disclosure describes and illustrates a particular I/O interface, this disclosure contemplates any suitable I/O interface.

In exemplary embodiments, communication interface 1710 includes hardware, software, or both providing one or more interfaces for communication (such as, for example, packet-based communication) between computer system 1700 and one or more other computer systems 1700 or one or more networks. As an example and not by way of limitation, communication interface 1710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1710 for it. As an example and not by way of limitation, computer system 1700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1700 may include any suitable communication interface 1710 for any of these networks, where appropriate. Communication interface 1710 may include one or more communication interfaces 1710, where appropriate. Although this disclosure describes and illustrates a particular communication interface, this disclosure contemplates any suitable communication interface.

In particular embodiments, bus 1712 includes hardware, software, or both coupling components of computer system 1700 to each other. As an example and not by way of limitation, bus 1712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1712 may include one or more buses 1712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A device, comprising:
a lens;
a plurality of cameras positioned behind the lens, wherein a first camera processes visible light, and a second camera processes infrared light;
a colored coating on the lens comprising a plurality of regions, each region comprising a color profile for selectively transmitting light, wherein a first region is positioned in front of the first camera, and a second region is positioned in front of the second camera; and
a processor and a non-transitory memory including computer-executable instructions, which when executed by the processor, cause the device to at least:
receive light information indicative of at least one of: visible light received at the first camera or infrared light received at the second camera, wherein the received light information provides environmental information for executing an operation on the device;
identify wavelengths reflected by the color profile positioned in front of each camera;
determine a color calibration for the light information based on the color profile, wherein the color calibration amplifies the wavelengths reflected by the color profile;
update the environmental information based on the color calibration; and
execute the operation on the device based on the updated environmental information.

2. The device of claim 1, further comprising a laser emitter positioned behind the lens; and a third region on the colored coating, the third region comprising a color profile for selectively transmitting infrared light.

3. The device of claim 1, wherein the colored coating comprises two first regions for selectively transmitting visible light, and the second region for selectively transmitting infrared light is centrally positioned between the two first regions.

4. The device of claim 1, wherein the colored coating comprises a first plurality of layers on an inner face of the lens, and a second plurality of layers on an outer face of the lens.

5. The device of claim 4, wherein the first plurality of layers comprises an inner ink layer, a middle hard-coat (HC) layer, and an outer anti-reflective (AR) layer.

6. The device of claim 5, wherein the inner ink layer is 6-28 micrometers, the middle HC layer is 9-30 micrometers, and the outer AR layer is 0.35-0.4 micrometers.

7. The device of claim 4, wherein the second plurality of layers comprises an inner hard-coat (HC) layer, a middle anti-reflective (AR) layer, and an outer anti-fingerprint (AF) layer.

8. The device of claim 7, wherein the inner HC layer is 9-10 micrometers, the middle AR layer is 0.35-0.4 micrometers, and the outer AF layer is 0.012-0.013 micrometers.

9. The device of claim 1, wherein the colored coating comprises a plurality of ink layers, and each ink layer reflects a range of wavelengths.

10. The device of claim 1, wherein the second region has less than a 20% transmission rate for wavelengths below 750 nm.

11. The device of claim 1, wherein the second region has less than a 10% transmission rate for wavelengths below 730 nm.

12. The device of claim 1, wherein the second region has less than a 5% transmission rate for wavelengths below 700 nm.

13. The device of claim 1, wherein the second region has greater than a 60% transmission rate for wavelengths above 850 nm.

14. The device of claim 1, wherein each region comprises an on-axis color profile, and an off-axis color profile.

15. The device of claim 14, wherein the on-axis color profile for at least one region has greater than a 90% transmission rate for wavelengths above 500 nm.

16. The device of claim 15, wherein the on-axis color profile for the at least one region has greater than a 96% transmission rate for wavelengths between 500-700 nm.

17. The device of claim 14, wherein the off-axis color profile for at least one region has a transmission rate of greater than 64% for wavelengths above 500 nm.

18. The device of claim 17, wherein the off-axis color profile for the at least one region has a transmission rate of greater than 73% for wavelengths between 500-700 nm.

19. The device of claim 1, wherein the first camera identifies at least one of red, green, blue, or yellow wavelength values.

20. The device of claim 1, wherein each color profile comprises a transmission profile and a reflection profile.

21. The device of claim 1, wherein the operation on the device is generating an image on a display.

22. The device of claim 1, wherein the operation on the device is executing a simultaneous location and mapping (SLAM) function.

23. The device of claim 1, wherein the colored coating is applied to the lens using at least one of a pad printing technique, a thermoformed technique, an injection molding technique, sputter deposition, and e-beam evaporation.

24. A computer-implemented method, comprising:
receiving light information at a plurality of cameras positioned behind a lens comprising a colored coating, wherein the colored coating comprises a plurality of regions each having a color profile, and wherein the light information is indicative of at least one of visible light or infrared light, and the light information provides environmental information for executing an operation on a computing device;
identifying wavelengths reflected by the color profile of a first region positioned in front of a first camera, and a second region positioned in front of a second camera;
determining a color calibration for the light information received at each camera, based on the color profile, wherein the color calibration amplifies wavelengths reflected by the color profile;
updating the environmental information based on the color calibration; and
executing the operation on the computing device based on the updated environmental information.

25. The computer-implemented method of claim 24, further comprising: transmitting light through a third region on the colored coating using a laser emitter, the third region comprising a color profile for selectively transmitting infrared light.

26. The computer-implemented method of claim 24, further comprising: receiving visible light transmitted through two first regions configured to selectively transmit visible light, and receiving infrared light through the second region configured to selectively transmit infrared light, wherein the second region is centrally positioned between the two first regions.

27. The computer-implemented method of claim 24, wherein the operation on the computing device comprises generating an image on a display.

28. The computer-implemented method of claim 24, wherein the operation on the computing device comprises executing a simultaneous location and mapping (SLAM) function.

29. The computer-implemented method of claim 24, wherein the second region has less than a 20% transmission rate for wavelengths below 750 nm.

30. The computer-implemented method of claim 24, wherein the second region transmits less than 10% of wavelengths below 730 nm.

31. The computer-implemented method of claim 24, wherein the second region transmits greater than 60% of wavelengths above 850 nm.

32. The computer-implemented method of claim 24, wherein each region comprises an on-axis color profile, and an off-axis color profile.

33. The computer-implemented method of claim 32, wherein the on-axis color profile for at least one region transmits greater than 90% of wavelengths above 500 nm.

34. The computer-implemented method of claim 32, wherein the off-axis color profile for at least one region transmits greater than 64% of wavelengths above 500 nm.

35. A system, comprising:
a lens;
a camera positioned behind the lens;
a colored coating on the lens, wherein the colored coating comprises at least one region comprising a reflection color profile and a transmission color profile; and
a camera module, associated with a device, comprising at least one processor and a non-transitory memory including computer-executable instructions, which when executed by the processor, cause the device to at least:
receive images from the camera, the images indicative of a view through the lens;
determine a color calibration based on the colored coating on the lens, wherein the color calibration amplifies the reflection color profile; and
update the received images based on the color calibration.

36. The system of claim 35, wherein the coating comprises at least one of a printed ink or a film.

37. The system of claim 36, wherein the printed ink is infrared transparent ink.

38. The system of claim 35, wherein the camera positioned behind the lens comprises an infrared camera and a visible spectrum camera.

39. The system of claim 35, wherein the lens is a curved lens.

40. The system of claim 35, wherein the device is a wearable headset.

41. The system of claim 35, wherein the transmission color profile and the reflection color profile each comprises a plurality of wavelengths.

42. The system of claim 41, wherein each of the plurality of wavelengths comprises a set of red, green, blue or yellow color values.

43. The system of claim 35, further comprising, adjusting a white balance of the received images.

44. The system of claim 35, wherein each region is positioned in front of the camera.

45. The system of claim 35, wherein the colored coating on the lens includes at least two regions with different transmission color profiles and reflection color profiles.

46. The system of claim 45, wherein the transmission color profiles and the reflection color profiles each comprise on-axis color values and off-axis color values.

47. The system of claim 35, further comprising three cameras positioned behind the lens, and three regions positioned in front of each camera.

48. The system of claim 35, wherein the camera module further comprises instructions to at least:
based on the color calibration, apply a third color profile from a light source, wherein the third color profile tunes the received images to compensate for the colored coating; and
dynamically adjust the color calibration when the received images indicate a change in the view through the lens.
